(19) United States
(12) Patent Application Publication
(10) Pub. No.: US 2025/0077953 A1
(43) Pub. Date: Mar. 6, 2025

(54) MANAGING EVOLVING ARTIFICIAL INTELLIGENCE MODELS

(71) Applicant: Dell Products L.P., Round Rock, TX (US)

(72) Inventors: OFIR EZRIELEV, Beer Sheva (IL); TOMER KUSHNIR, Omer (IL); AMIHAI SAVIR, Newton, MA (US)

(21) Appl. No.: 18/459,109

(22) Filed: Aug. 31, 2023

(51) Int. Cl. G06N 20/00

(52) U.S. Cl. CPC G06N 20/00

(57) ABSTRACT

Methods and systems for managing evolving artificial intelligence (AI) models are disclosed. The evolving AI models may be used to generate inferences that may be provided to downstream consumers during a provisioning process. The downstream consumers may rely on the accuracy and consistency of the inferences provided during the provisioning process to provide desired computer-implemented services. The AI models may be updated (e.g., with new training data) automatically and/or frequently over time in order to increase the accuracy of inferences provided by the AI model. However, inferences provided by a newly updated instance of an AI model may be inconsistent with inferences provided by prior instances of the AI model (e.g., due to AI model poisoning). Therefore, to increase the likelihood of providing accurate and consistent (e.g., unpoisoned) inferences to the downstream consumers, an appropriate instance of the AI model may be identified for use in the provisioning process.

### FIELD

Embodiments disclosed herein relate generally to artificial intelligence (AI) models. More particularly, embodiments disclosed herein relate to systems and methods to manage instances of AI models.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2A shows a data flow diagram illustrating a training process for an AI model in accordance with an embodiment.

FIG. 2B shows a data flow diagram illustrating a training process for identifying an instance of an AI model in accordance with an embodiment.

FIGS. 3A-3B show flow diagrams illustrating methods of managing evolving AI models in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing AI models. Trained AI models may provide computer-implemented services (e.g., inference generation) for downstream consumers and/or facilitate computer-implemented services provided by the downstream consumers. For example, downstream consumers may perform a provisioning process during which inferences generated using a trained AI model are obtained. Over time, the AI models may be updated using a training process and (newly acquired) training data in order to maintain and/or increase the accuracy of inferences generated by the AI models. For example, AI models may be updated (e.g., may evolve) automatically as AI model update conditions are met (e.g., new training data is made available for updating the AI model) to generate different instances of the AI models.

To provide high-quality (e.g., accurate) inferences to the downstream consumers, the provisioning process may use the most up to date instance (e.g., version) of the AI model for inference generation. However, the different instances of the AI model obtained as a result of the update process (e.g., training process) may not generate inferences consistent with one another (e.g., by virtue of the different instances of the AI models being distinct).

In addition, the update process may be susceptible to attacks (e.g., by malicious parties). For example, a malicious party may take advantage of a connection (e.g., to a system managing the AI models and/or their training processes) established during a provisioning process to introduce poisoned training data to the AI models in an attempt to poison one or more AI models in real-time (e.g., while model updates are automatically occurring). Poisoned training data may include, for example, biased training data and/or other types of training data designed to poison an AI model. Inferences generated by a poisoned AI model may be untrustworthy and/or inaccurate, and therefore may negatively affect the downstream consumers and/or the computer-implemented services provided by the downstream consumers.

For example, if an AI model update process is occurring during the same period of time as a provisioning process that is using the most up to date instance of the AI model for inference generation, then different instances of the AI model may be used resulting in inconsistent and/or poisoned inferences being provided to the downstream consumer during the provisioning process. Thus, the provisioning process may not rely on using the most up to date (e.g., most accurate) instances of the AI model to provide a set of consistent inferences to the downstream consumer.

To increase the likelihood of providing a set of consistent inferences to a downstream consumer during a provisioning process, an instance of the AI model may be identified based on information regarding the provisioning process and/or the downstream consumer. Further, update processes may be suspended for a period of time (e.g., during the provisioning process) to mitigate and/or prevent real-time AI model poisoning (e.g., by creating a time gap for an opportunity to analyze training data and/or updated AI models to detect poisoning).

By doing so, embodiments disclosed herein may provide a system for managing evolving AI models in which updated instances of the AI models and/or the introduction of poisoned training data may reduce the quality of the computer-implemented services.

In an embodiment, a method for managing evolving artificial intelligence (AI) models is provided. The method may include: making an identification that a downstream consumer will perform a process, the process including consuming inferences from an AI model of the evolving AI models, the AI model being subject to an update process, and the update process being used to generate different instances of the AI model; and, while the process is being performed, providing a set of consistent inferences to the downstream consumer using an instance of the different instances of the AI model to facilitate completion of the process.

Providing the set of consistent inferences may include identifying the instance of the AI model usable to generate the set of consistent inferences for the downstream consumer, and obtaining the set of consistent inferences using the instance of the AI model.

Identifying the instance of the AI model may include suspending the update process for the instance of the AI model, and using a most up to date instance of the AI model as the instance of the AI model. Identifying the instance of the AI model may further include performing an action set to initiate resumption of the update process for the instance of the AI model to obtain an updated instance of the AI model.

The action set may include identifying a period of time for the process to complete, and waiting at least the period of time before performing an action of the action set to resume performance of the update process.

Identifying the instance of the AI model may include, during the process, identifying a first instance of the AI model used to service a first inference request for inferences used in the process, and using the first instance of the AI model as the instance of the AI model.

Using the first instance of the AI model as the instance of the AI model may include: during the process, after identifying the first instance of the AI model, identifying that a second instance of the AI model has been generated by the update process, the second instance of the AI model being an updated version of the first instance of the AI model; and, after identifying that the second instance of the AI model has been generated, servicing all subsequent requests for inferences used in the process with the first instance of the AI model rather than the second instance of the AI model and any subsequent instance of the AI model generated by the update process to provide the set of consistent inferences.

At a time of identification of the first instance of the AI model, the first instance of the AI model may be a most up to date version of the AI model.

Facilitating completion of the process may include providing a computer-implemented service using the set of consistent inferences.

A non-transitory media may include instructions that when executed by a processor cause the computer-implemented method to be performed.

A data processing system may include the non-transitory media and a processor, and may perform the computer-implemented method when the computer instructions are executed by the processor.

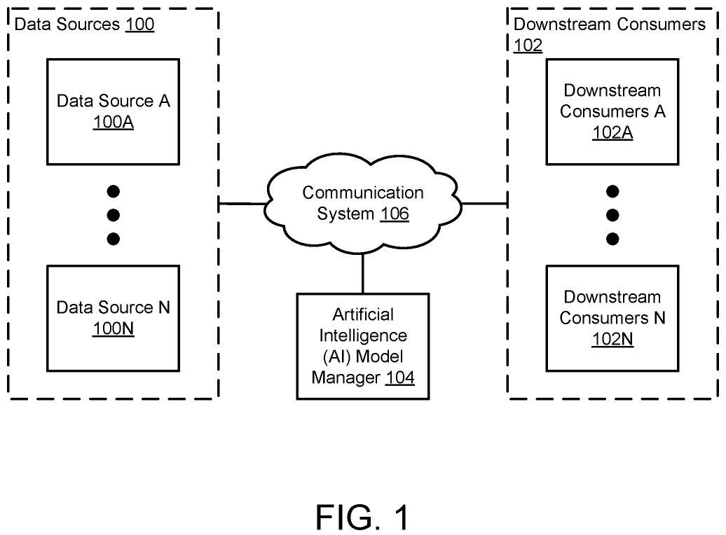

Turning to FIG. 1, a block diagram illustrating a system in accordance with an embodiment is shown. The system shown in FIG. 1 may provide computer-implemented services that may utilize AI models as part of the provided computer-implemented services. The computer-implemented services may include any type and quantity of services including, for example data services (e.g., data storage, access and/or control services), communication services (e.g., instant messaging services, video-conferencing services), and/or any other type of service that may be implemented with a computing device.

The computer-implemented services may be provided by one or more components shown in the system of FIG. 1. For example, data sources 100, downstream consumers 102, AI model manager 104, and/or any other type of devices (not shown in FIG. 1) may perform the computer-implemented services, at least in part, using AI models and/or inferences obtained with the AI models.

The AI models may, for example, be implemented with artificial neural networks, decision tress, regression analysis, and/or any other type of model usable for learning purposes. Data obtained from data sources 100 may include, for example, (i) training data (e.g., used to train the AI models to perform the computer-implemented services), (ii) ingest data (e.g., used as input to the trained AI models in order to perform the computer-implemented services), and/or (iii) other types of data that may be usable for the implementation of AI models. Data obtained via data sources 100 may facilitate the generation of various AI models that may be used for various purposes. For example, the AI models may be trained to recognize patterns, automate tasks, and/or make decisions based on data input to (e.g., ingested by) the AI models.

Data sources 100 may include any number and/or type of data sources (e.g., 100A, 100N). Each data source of data sources 100 may include hardware and/or software components configured to obtain data, store data, provide data to other entities, and/or to perform any other task to facilitate performance of the computer-implemented services. All, or a portion, of data sources 100 may provide (and/or participate in and/or support the) computer-implemented services to various computing devices operably connected to data sources 100. Different data sources may provide similar and/or different computer-implemented services. Data sources 100 may provide data to AI model manager 104.

To provide the computer-implemented services, AI model manager 104 may (i) obtain training data and/or ingest data (e.g., from data sources 100), (ii) obtain an AI model (e.g., an untrained instance of the AI model and/or trained instances of the AI model), (iii) obtain a trained AI model instance (e.g., initiate training of an instance of the AI model using the training data), (iv) obtain inferences using the trained instance of the AI model and the ingest data, and/or (v) perform other tasks related to AI models and/or related to providing the computer-implemented services. For example, AI model manager 104 may provide data (e.g., inferences) to other entities (e.g., downstream consumers 102), as part of a computer-implemented service.

Downstream consumers 102 may provide and/or consume all, or a portion of the computer-implemented services. Downstream consumers 102 may include any number of downstream consumers (e.g., 102A, 102N) and may include, for example, businesses, individuals, and/or computers that may use inference data to improve and/or automate decision-making.

For example, downstream consumers 102 may consume inferences obtained from an instance of an AI model (e.g., managed by AI model manager 104). To do so, downstream consumers 102 may initiate a process during which inferences are consumed using the instance of the AI model (e.g., a provisioning process). The provisioning process may last a period of time before completing, during which a secure connection between a first device of downstream consumers 102 and a second device managed by AI model manager 104 may be established in order to transmit (e.g., provide) the inferences to the downstream consumer.

Over time, new versions (e.g., instances) of an AI model may be obtained. For example, the AI model may be an evolving AI model, which may automatically and/or frequently undergo an update process (e.g., a training process using newly acquired training data). The update process for an AI model may be computationally costly because training may require significant resource expenditures (e.g., of computing resources). Therefore, to obtain different instances of an AI model (e.g., an evolving AI model), existing instances of the AI models may be used as a basis for new AI models, thereby leveraging the existing resource expenditures used to obtain the existing AI models. For example, updating instances of the AI models may be obtained through training (e.g., incremental learning) as more training data is obtained (e.g., from data sources 100).

Updated versions (e.g., instances) of AI models may be obtained for various reasons (e.g., based on one or more update conditions being met). For example, an AI model may be updated (e.g., automatically) to obtain a newer instance of the AI model based on (i) an availability of new training data (e.g., the AI model may be updated if a sufficient amount of new training data has been gathered for updating purposes, based on comparison between the a current volume of training data to a training data volume threshold), (ii) an accuracy of inferences obtained from the AI model (e.g., the AI model may be updated if the inference accuracy is unsatisfactory, based on a comparison between the accuracy of the current inferences to an inference accuracy threshold), (iii) an update schedule for the AI model (e.g., the AI model may be updated according to a schedule that fits business needs, based on a comparison between when the trained AI model was last updated and the current point in time), (iv) a request for an update for the AI model (e.g., the AI model may be updated if a downstream consumer and/or other entity requests the update), and/or (v) other reasons that may use a basis of comparison between the current characteristics of the AI model, training data, etc.

However, different instances (e.g., consecutive versions) of an AI model may provide inconsistent inferences. For example, inferences obtained from a first version of an AI model and a second (e.g., updated) version of an AI model may be inconsistent due to differences in the quality of the training data used to update the AI model. For example, the content and/or accuracy (e.g., on average) of inferences obtained from consecutively updated instances of an AI model may be inconsistent depending on the training data used in the update process.

In addition, while the intention of updating an AI model may be to improve the quality of the AI model (e.g., improve the accuracy of its inferences, the usability of its inferences by downstream consumers, etc.), the update process for the AI model may be susceptible to attacks. For example, a malicious party may intentionally provide poisoned (e.g., low quality, biased, anomalous, etc.) training data to an AI model update process in order to influence the inferences of updated instances of the AI model. For example, if poisoned training data is used to train a latest instance of the AI model (e.g., from a previous instance of the AI model), then the latest instance of the AI model may not be an improved version of the previous instance of the AI model and/or the latest instance of the AI model may generate poisoned inferences.

For evolving AI models that may undergo the update process automatically and/or frequently (e.g., if update conditions are being met frequently), the AI model update process may be initiated prior to and/or may occur during a provisioning process (e.g., initiated by a downstream consumer), resulting in the downstream consumer being (unknowingly) provided with inconsistent (e.g., poisoned) inferences. For example, a malicious party may provide poisoned training data that results in a small but tailored (e.g., to a downstream consumer) change in the operation of an evolving AI model. Consequently (e.g., due to the small change in the evolving AI model), this type of attack may be difficult to detect. To prevent the types of attacks as noted above, embodiments disclosed herein may limit when different instances of AI models may be used to provide inferences for a downstream use over a known period of time (e.g., during a provisioning process for a downstream consumer). By preventing different instances of AI models from being used during the known period of time, even if an attacker knows which instance of the AI model is being used for the downstream use, the attacker will not be able to exploit this knowledge by injecting poisoned training data that would otherwise be used to update the evolving AI model during the downstream use.

Downstream consumers (e.g., 102) may rely on the consistency of the inferences (e.g., consistently accurate and/or unpoisoned inferences) obtained during a provisioning process in order to provide reliable computer-implemented services. Therefore, the provision of inconsistent inferences to downstream consumers may reduce the quality of the computer-implemented services provided to and/or by the downstream consumers and/or may otherwise impact the downstream consumers in an undesirable manner.

In general, embodiments disclosed herein may provide methods, systems, and/or devices for managing (instances of) AI models. The AI models may be managed in a manner that allows for the provision of consistent inferences as requested by downstream consumers. By doing so, the system may be more likely to be able to provide and/or facilitate the desired computer-implemented services.

To manage instances of an (evolving) AI model, AI model manager 104 may (i) manage storage of and/or access to the instances of an AI model, (ii) manage update processes for the AI model, and/or (iii) facilitate the provision of consistent inferences (e.g., of a given instance of the AI model) to downstream consumers during a provisioning process.

To manage the different instances of the AI model, AI model manager 104 may store one or more instances (e.g., deprecated versions and/or a latest version) of the AI model in a repository. Upon initiation of a provisioning process (e.g., by a downstream consumer), an instance of the AI model may be selected from the repository for use in providing inferences that may be requested by the downstream consumer.

To manage the update process for the AI model, AI model manager 104 may initiate, suspend, resume, and/or modify an update process for the AI model (e.g., based on one or more provisioning processes initiated by one or more downstream consumers). For example, the update process may be suspended during the provisioning process (i) in order to mitigate and/or prevent real-time tampering of the AI model (e.g., the introduction of poisoned training data by a malicious party during the update process) and/or (ii) for other reasons, such as preserving limited computing resources, etc. The update process may, for example, be modified by delaying the update process for a period of time (e.g., the period of time occurring after training data intended for use in the update process has been obtained).

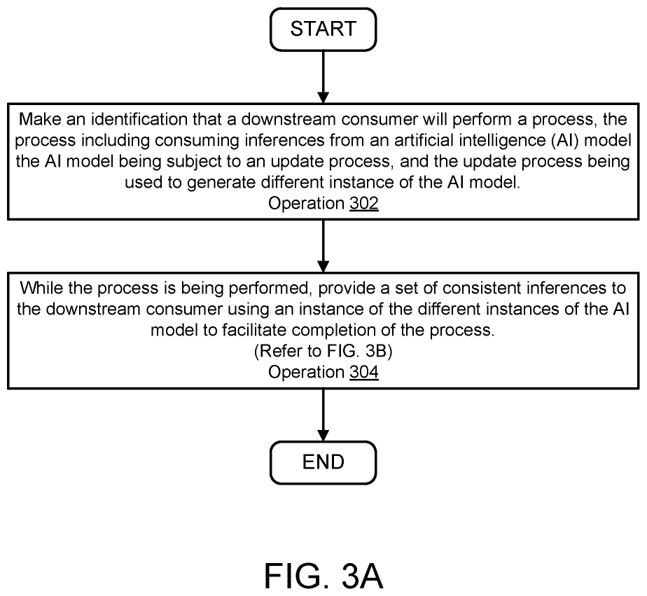

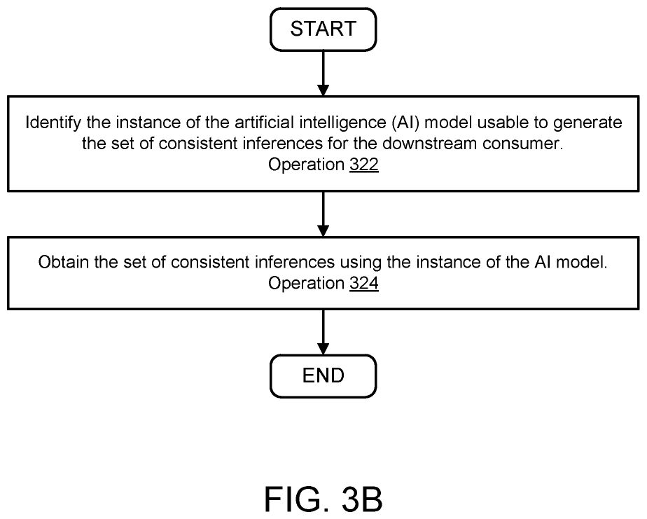

When providing their functionality, any of data sources 100, downstream consumers 102, and/or AI model manager 104 may perform all, or a portion of the methods shown in FIGS. 3A-3B.

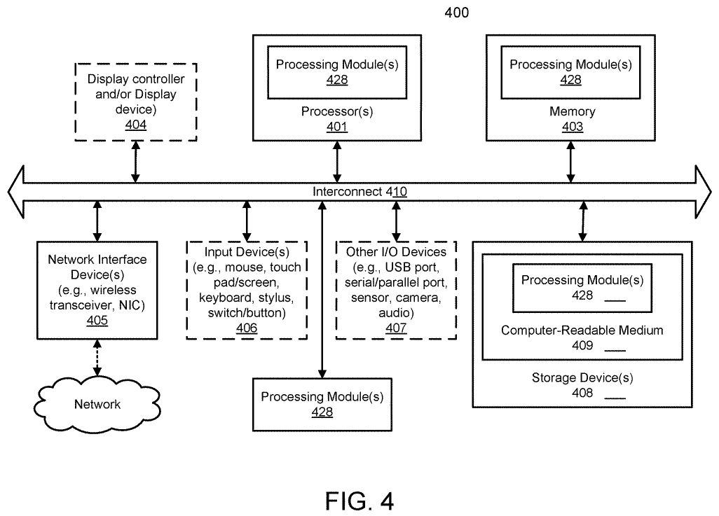

Any of (and/or components thereof) data source 100, downstream consumers 102, and/or AI model manager 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to FIG. 4.

In an embodiment, one or more of data sources 100, downstream consumers 102, and/or AI model manager 104 are implemented using an internet of things (IoT) device, which may include a computing device. The IoT device may operate in accordance with a communication model and/or management model known to data sources 100, downstream consumers 102, AI model manager 104, and/or other devices.

Any of the components illustrated in FIG. 1 may be operably connected to each other (and/or components not illustrated) with communication system 106. In an embodiment, communication system 106 includes one or more networks that facilitate communication between any number of components. The networks may include wired networks and/or wireless networks (e.g., and/or the Internet). The networks may operate in accordance with any number and/or types of communication protocols (e.g., such as the internet protocol). Communication system 106 may be implemented with one or more local communications links (e.g., a bus interconnecting a processor of AI model manager 104 and any of the data sources 100 and downstream consumers 102).

While illustrated in FIG. 1 as included a limited number of specific components, a system in accordance with an embodiment may include fewer, additional, and/or different components than those illustrated therein.

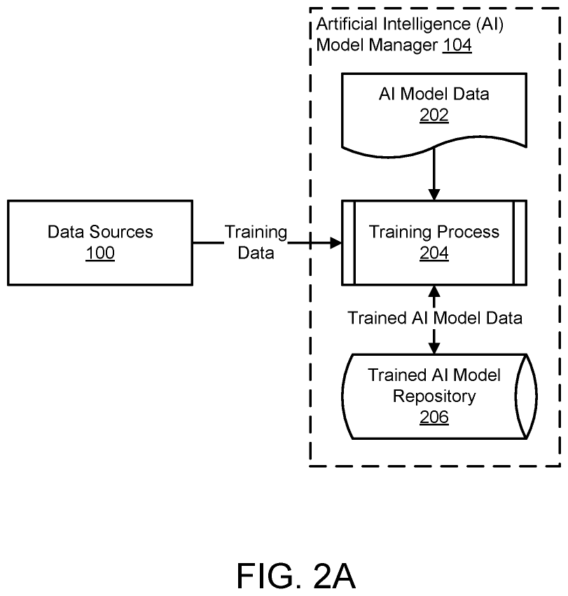

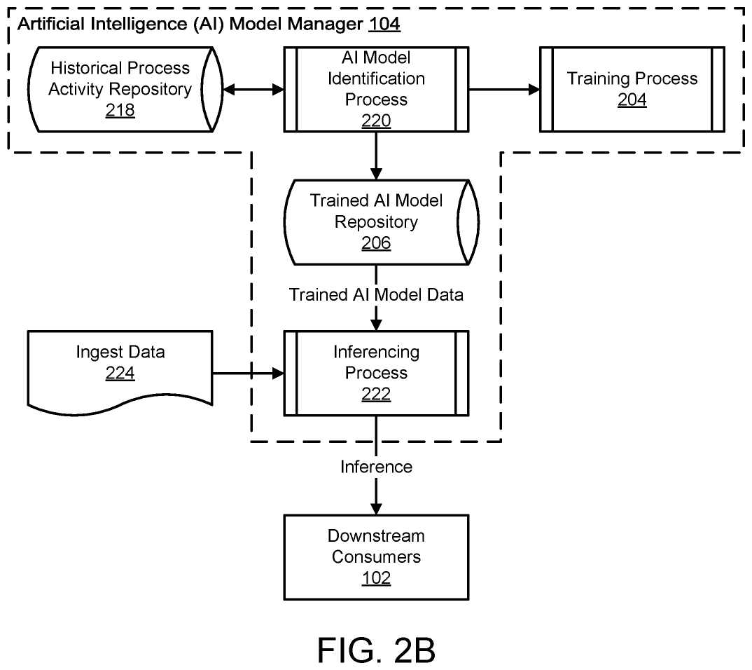

To further clarify embodiments disclosed herein, diagrams illustrating data flows implemented by a system over time in accordance with an embodiment are shown in FIGS. 2A-2B. In these diagrams, flows of data and processing of data are illustrated using different sets of shapes. A first set of shapes (e.g., 202, 224) is used to represent data structures, a second set of shapes (e.g., 204, 220, etc.) is used to represent processes performed using data, and a third set of shapes (e.g., 206) is used to represent large scale data structures such as databases.

The processes shown in FIGS. 2A-2B may be performed by any entity shown in the system of FIG. 1 (e.g., an AI model manager similar to AI model manager 104, a downstream consumer similar to one of downstream consumers 102, etc.) and/or another entity without departing from embodiments disclosed herein.

Turning to FIG. 2A, a first data flow diagram in accordance with an embodiment is shown. The first data flow diagram may illustrate data used in and data processing performed in training an AI model. To train the AI model, AI model manager 104 may use AI model data 202 for training process 204. AI model data 202 may include information regarding the architecture and/or hyperparameters of the AI model (e.g., optimization algorithm information, hidden layer information, bias function descriptions, activation function descriptions, etc.).

An AI model type may be selected based on performance goals and/or constraints, training data availability and/or quality, budget, timeline, etc. For example, a complex AI model such as a multi-layered neural network may process a large amount of complex data and generate highly accurate inferences, but may be costly to train and maintain and may have low explainability (e.g., may act as a “black box”). In contrast, a linear regression model may be a simpler, less costly AI model with high explainability, but may only be well-suited for data whose labels are linearly correlated with the selected features, and may generate less accurate inferences than a neural network. In addition, simpler AI models may be more resistant to attacks than complex AI models.

Data sources 100 may provide training data to AI model manager 104. The training data may be obtained in real-time (e.g., via a data pipeline) and/or may be obtained from storage (e.g., from a training data repository managed by one or more of data sources 100). The training data may include data that defines an association between two pieces of information (e.g., a sample input associated with a sample output, the pair being labeled data).

To train an AI model, AI model manager 104 may use AI model data 202 to perform training process 204. Using AI model constraints defined by AI model data 202, training process 204 may include obtaining an untrained AI model. The untrained AI model may be trained during training process 204 using the training data obtained from data sources 100. For example, training process 204 may employ supervised learning to train an AI model to associate a desired output sample of the training data with an input sample of the training data. Large numbers of associations may be trained into the AI model (e.g., using various combinations of input samples and output samples from the training data).

The resulting trained AI model may be able to predict a desired output from sample input not included in the training data (e.g., the trained AI model may be used to generate an inference based on ingest data). While the model is being trained, the AI model parameters may evolve (e.g., be updated based on new training data associations). For example, depending on the type of AI model being updated, values of model parameters such as coefficient, weight, bias, and/or cluster centroid values of the AI model may be modified.

Training process 204 may include training any number of different types of AI models. To manage the (trained) AI models, trained instances of the AI models may be stored in trained AI model repository 206. To do so, training process 204 may include providing AI model data of the trained instances (e.g., trained AI model data) to trained AI model repository 206. Trained AI model data may include AI model data (e.g., information regarding the architecture and/or hyperparameters of the AI model) and/or model parameter values of the instances of the AI models.

Trained AI model data may be stored along with other information regarding the AI model instance. For example, other information regarding the AI model instance may include (i) an AI model identifier (e.g., identifying the type and/or purpose of the AI model), (ii) a version identifier for the AI model instance, (iii) training data identifiers (e.g., to identify training data used to train/update the AI model instance), (iv) timestamp information (e.g., indicating time periods when the AI model instance was in use, when the instance of the AI model was obtained and/or last updated, etc.), and/or (v) other information usable for identifying and/or tracking instance of the AI model.

Trained AI model repository 206 may store and/or provide access to any number of AI models (e.g., AI model data) and/or AI model instances (e.g., trained AI model data). For example, trained AI model repository 206 may provide trained AI model data to training process 204 for use in updating instances of the (previously trained) AI models.

Training process 204 may include updating (e.g., further training) any number of instances of different AI models. For example, when one or more update conditions are met for an AI model, AI model manager 104 may prompt training process 204 to select an AI model instance stored in trained AI model repository 206. The selected AI model instance may undergo training process 204, for example, using new training data obtained from data sources 100. The resulting updated AI model instance may be stored in trained AI model repository 206 along with other information regarding the updated AI model instance (e.g., a version number, timestamp, etc.).

As updated instances of the AI model are obtained, the instances (e.g., updated instances and/or prior instances) may be evaluated (e.g., via model testing which may use portions of training data designated for doing so). For example, the evaluation of an instance of the AI model may indicate that the instance of the AI model is inaccurate (e.g., an average inference accuracy score may fall below a threshold), does not provide desired types of inferences (e.g., based on needs of a downstream consumer), etc. Consequently, as part of the AI model management process, AI model manager 104 may prompt trained AI model repository 206 to remove, replace, or retain deprecated (e.g., previous) versions of the AI model.

Thus, as illustrated in FIG. 2A, the system of FIG. 1 may obtain and/or train (e.g., update) instances of AI models. The instances of the AI models may be managed using a repository that may store and/or provide access to the instances of the AI models. For example, one or more trained AI models (e.g., trained AI model data) may be identified from trained AI model repository 206 and/or may be implemented (e.g., by AI model manager 104) in order to service requests for inferences from one or more downstream consumers.

Turning to FIG. 2B, a second data flow diagram in accordance with an embodiment is shown. The second data flow diagram may illustrate data used in and data processing performed for identifying an instance of an AI model. As discussed previously, AI models may be updated over time, resulting in different instances of the AI models (e.g., latest versions, deprecated versions, etc.) being available for inference generation during a provisioning process (e.g., initiated and/or performed by a downstream consumer). In order to provide a set of consistent inferences to the (initiating) downstream consumer, an appropriate instance of the AI model may be identified to be used in a provisioning process.

To identify an (appropriate) instance of the AI model (e.g., appropriate for obtaining the set of consistent inferences requested by the downstream consumer), AI model manager 104 may perform AI model identification process 220. Prior to performing AI model identification process 220, AI model manager 104 may obtain a notification indicating that a downstream consumer intends to perform a process (e.g., a provisioning process during which a set of consistent inferences may be consumed by the downstream consumer) (not shown). For example, the downstream consumer may initiate the provisioning process (e.g., by making information regarding the provisioning process available to AI model manager 104).

AI model identification process 220 may obtain the information regarding the provisioning process, for example, via AI model manager 104. The information regarding the provisioning process may include, for example, (i) an initiation time of the provisioning process, (ii) identifying information for the initiator of the provisioning process (e.g., the downstream consumer), (iii) information regarding a type of inference that may be requested during the provisioning process (e.g., indicating the type of AI model that may be used to obtain the type of inference), (iv) other information useful for facilitating the provisioning process (e.g., information for establishing a connection with a device of the downstream consumer, information for validating security of the connection, etc.).

Using information regarding the provisioning process, AI model identification process 220 may include obtaining historical process activity information associated with the initiator from historical process activity repository 218. For example, historical process activity repository 218 may be managed by a database, and AI model identification process 220 may use the identifying information for the initiator to query the database in order to obtain historical process activity information relevant to the initiator.

Historical process activity information may include, for example, (i) time period information for historical processes for one or more initiators of the provisioning processes (e.g., initiation times, completion times, period of times for the provisioning process to complete, etc.), (ii) identifiers for AI models (e.g., and instances thereof) used to obtain inferences during the historical processes, (iii) information regarding ingest data for which the inferences were based on during the historical processes (e.g., ingest data sources, ingest data type, etc.), and/or (iv) other information relevant to the historical process activity of the one or more initiators of the provisioning processes (e.g., security posture information, historical data transmission efficiency, etc.).

For example, a downstream consumer may initiate a provisioning process, for which AI model identification process 220 may query historical process activity repository 218 to obtain historical process activity information regarding the provisioning process and/or the downstream consumer. Based on the historical process activity information, AI model identification process 220 may identify instances of AI models associated with historical and/or current (e.g., ongoing) provisioning processes initiated by the downstream consumer, and/or estimate a period of time for the current provisioning process (e.g., based on periods of times for one or more historical provisioning processes).

Information regarding any number of downstream consumers and/or any number of historical processes (e.g., initiated by one or more of the downstream consumers) may be stored in historical process activity repository 218. The information stored in historical process activity repository 218 may be accessed (e.g., by AI model identification process 220 and/or via AI model manager 104), for example, in order to identify the instance of the AI model (e.g., appropriate for obtaining the set of consistent inferences).

AI model identification process 220 may use the historical process activity information and/or the information regarding the provisioning process to (i) identify a period of time for the provisioning process to complete (e.g., a completion time for the provisioning process, based on the historical process activity of the initiator and the initiation time of the provisioning process), (ii) identify AI models (e.g., instances of the AI models) associated with the initiator and/or the provisioning process, (iii) suspend and/or resume update processes for AI models associated with the initiator and/or the provisioning process (e.g., suspend and/or resume performance of update processes such as training process 204, based on the period of time for the provisioning process to complete), and/or (iv) perform other functions related to the management of the instances of the AI models and/or update processes for the AI models.

The provisioning process may include transmitting one or more requests for inferences (e.g., from the downstream consumer to AI model manager 104). AI model identification process 220 may include identifying the AI model (and instance thereof) that may be used to service the one or more requests for inferences by providing the inferences (e.g., the set of consistent inferences) to the initiator (e.g., downstream consumer).

For example, AI model identification process 220 may result in identifying a first instance of the AI model. To do so, AI model identification process 220 may include providing information to trained AI model repository 206. For example, AI model identification process 220 may include querying a database managing trained AI model repository 206. The database query may include key words based on information regarding the provisioning process and/or historical process activity information. The database query may return identifying information for the first instance of the AI model.

The first instance of the AI model may include the most up to date instance (e.g., version) of the AI model at the time of its identification (e.g., at the time the provisioning process was initiated by the downstream consumer, or at the time the first inference request was received and/or serviced). To obtain inferences (e.g., of the set of consistent inferences) using the first instance of the AI model, trained AI model repository 206 may provide access to trained AI model data (e.g., of the first instance of the AI model) to facilitate inferencing process 222.

Inferencing process 222 may include using parameter constraints and/or values (e.g., node information, weight information, connection information, activation functions, etc.) included in the trained AI model data to obtain the first instance of the AI model. To service the requests for inferences, inferencing process 222 may include receiving ingest data 224 (e.g., obtained from data sources 100, downstream consumers 102, and/or another entity).

Ingest data 224 may include a portion of data for which an inference is desired to be obtained. Ingest data 224 may not include labeled data and, thus, an association for ingest data 224 may not be known. For example, inferencing process 222 may include using ingest data 224 as input to the first instance of the AI model in order to service a first inference request for inferences used in the provisioning process.

During inferencing process 222 (e.g., while inference requests are being serviced using the first instance of the AI model), the AI model may be updated (e.g., by performing training process 204 using new training data and the first instance of the AI model, as described with respect to FIG. 2A). The AI model update process may generate a second instance (e.g., an updated version) of the AI model, which may result in the first instance of the AI model being a deprecated version of the AI model.

Following the generation of the second instance of the AI model, all subsequent requests for inferences used in the provisioning process (e.g., requests for inferences received after the second instance of the AI model is updated) may be serviced by the first instance of the AI model. By using the first instance of the AI model to service all subsequent requests for inferences (rather than the second instance of the AI model and/or any subsequent instances of the AI model generated by the AI model update process), the inferences obtained during inferencing process 222 may be consistent.

Alternatively, once inferencing process 222 is initiated (e.g., once trained AI model repository 206 has provided access to the trained AI model data to facilitate inferencing process 222), training process 204 may be suspended to prevent additional AI model update processes for the AI model (e.g., the AI model may be an evolving AI model that may be subject to automatic and/or frequent updates). While the update process is suspended, the first instance of the AI model (e.g., the most up to date instance of the AI model) may be used by inferencing process 222 to service incoming inference requests.

For example, the AI model update process may be suspended for at least the estimated period of time for the provisioning process to complete (e.g., the period of time for the provisioning process to complete identified during AI model identification process 220). The first instance of the AI model may be used to service all inference requests during the provisioning process until the provisioning process has completed.

By using the first instance of the AI model (regardless of more up to date instances of the AI model being available) and/or by suspending the AI model update process for at least the period of time of the provisioning process, (i) the likelihood of providing consistent inferences to the downstream consumer may be increased, and/or (ii) the likelihood of a real-time attack on the AI model may be reduced. For example, a malicious party may attempt to exploit a connection (e.g., between AI model manager 104 and the downstream consumer) that is established for the provisioning process as part of a real-time attack to the AI model (e.g., by providing poisoned training data to training process 204). Reducing the likelihood of the real-time attack may also increase the likelihood of providing consistent inferences to the downstream consumer during the provisioning process.

Once the provisioning process has completed, an action set may be performed to initiate resumption of the AI model update process to obtain an updated instance of the AI model. The action set may include, for example, (i) identifying training data obtained during the period of time (e.g., while the provisioning process was ongoing), (ii) analyzing the identified training data (e.g., to detect portions of poisoned training data in the identified training data), (iii) selecting and/or omitting training data to be used in future update processes (e.g., based on the analysis of the identified data), and/or (iv) initiating resumption of the update process (e.g., waiting at least the period of time for the provisioning process to complete before resuming the update process). Once the update process has been resumed, updated instances of the AI model may be obtained and/or may be stored in trained AI model repository 206 for use in future inferencing and/or provisioning processes.

The inferences (e.g., of the set of consistent inferences) generating during the provisioning process may be obtained by AI model manager 104 and/or may be provided to the initiator (e.g., downstream consumers 102) in order to facilitate completion of the provisioning process. Upon completion of the provisioning process, any established connections (e.g., for data transfer) between downstream consumers 102 and AI model manager 104 may be closed. One or more of downstream consumers 102 may use at least a portion of the set of consistent inferences to provide all, or a portion of a computer-implemented service.

Thus, as illustrated in FIG. 2B, the system of FIG. 1 may identify an instance of an AI model that may be more likely to generate consistent inferences during a provisioning process initiated by the downstream consumers. Instances of the AI models may be selected from a repository that may store, organize, and/or provide access to the instances of the AI models. For example, one or more trained AI models (e.g., trained AI model data) may be identified from trained AI model repository 206 and/or may be implemented (e.g., by AI model manager 104) in order to service requests for inferences from one or more downstream consumers. The selected instance of the AI models may be more likely to provide the downstream consumer with consistent (e.g., unpoisoned, in the case of an attack on the AI model) inferences, which may be relied upon by the downstream consumer in order to provide the desired computer-implemented services.

In an embodiment, the one or more entities performing the operations shown in FIGS. 2A-2B are implemented using a processor adapted to execute computing code stored on a persistent storage that when executed by the processor performs the functionality of the system of FIG. 1 discussed throughout this application. The processor may be a hardware processor including circuitry such as, for example, a central processing unit, a processing core, or a microcontroller. The processor may be other types of hardware devices for processing information without departing from embodiments disclosed herein.

As discussed above, the components of FIG. 1 may perform various methods to manage AI models. FIGS. 3A-3B illustrate methods that may be performed by the components of FIG. 1. In the diagram discussed below and shown in FIGS. 3A-3B, any of the operations may be repeated, performed in different orders, and/or performed in parallel with or in a partially overlapping in time manner with other operations. The methods may be performed by a data processing system, and/or another device.

Turning to FIG. 3A, a flow diagram illustrating a method of managing (evolving) AI models in accordance with an embodiment is shown.

At operation 302, an identification that a downstream consumer will perform a process (e.g., a provisioning process) may be made. The identification may be made by (i) receiving a request for connection for the provisioning process (e.g., from a downstream consumer and/or a third-party device), (ii) reading the request for connection for the provisioning process (e.g., from storage), and/or (iii) obtaining (e.g., generating) a prediction indicating that the downstream consumer will perform the process. For example, the prediction may be generated by an AI model trained to predict the future activity of downstream consumers based on historical process activity of the downstream consumers. The prediction may include information such as a predicted start time for the process, a predicted end time for the process, etc.

The provisioning process may include consuming inferences from an AI model. The AI model may be, for example, an evolving AI model that may be subject to frequent and/or automatic updates (e.g., based on update conditions being met). The update process may generate different instances of the AI model over time (e.g., during the provisioning process), and the different instances may generate inconsistent inferences (e.g., from consistent ingest data); therefore, an instance of the AI model usable to obtain consistent inferences for the duration of the provisioning process may be identified as part of operation 304.

At operation 304, while the process (e.g., the provisioning process) is being performed, a set of consistent inferences may be provided to the downstream consumer using an instance of the different instances of the AI model. The set of consistent inferences may be provided by making the set of consistent inferences available to the downstream consumer (e.g., for download via a connection established for the provisioning process). The set of consistent inferences may be generated and/or obtained (e.g., using the instance of the AI model) by a third party; therefore, the third party may provide the set of consistent inferences by transmitting (e.g., via a connection established during the provisioning process) the set of consistent inferences to the downstream consumer.

The set of consistent inferences may be provided via the method illustrated in FIG. 3B. Once provided to the downstream consumer, the set of consistent inferences may facilitate completion of the provisioning process identified in operation 302. The downstream consumer may perform and/or improve a computer-implemented service using the set of consistent inferences. For example, the downstream consumer may use (e.g., analyze) a set of consistent inferences regarding a user to personalize the user's experience of the computer-implemented service.

The method may end following operation 304.

Turning to FIG. 3B, a flow diagram illustrating a method of identifying an instance of an AI model in accordance with an embodiment is shown. In FIG. 3B, operations 322-324 of may be an expansion of operation 304 (shown in FIG. 3A).

At operation 322, the instance of the AI model usable to generate the set of consistent inferences for the downstream consumer may be identified. The instance of the AI model may be identified by querying a database that manages a repository (e.g., trained AI model repository 206) storing the different instances of the AI model. For example, the database query may return an entry for a most up to date instance of the AI model (e.g., the most up to date instance of the AI model at the time of initiation of the provisioning process described with respect to operation 302). The database query may prompt the repository to provide trained AI model data for the most up to date instance of the AI model for use in a process that may generate inferences using the trained AI model data (e.g., inferencing process 222 of FIG. 2B).

In a first example, identifying the instance of the AI model may include suspending the update process for the instance of the (identified) AI model. For example, the update process may be suspended by (i) holding the (identified) AI model in a data structure in a priority queue (e.g., a heap) according to a period of time to suspend the update process, and/or (ii) transmitting a notification to the update process (e.g., training process 204). The notification may include, for example, instructions that may identify the AI model instance, and/or that may include the period of time to suspend the update process of the AI model instance. Identifying the instance of the AI model may include using the most up to date instance of the AI model (e.g., which may be identified via the database query described above) as the instance of the AI model (e.g., while the update process is suspended).

Identifying the instance of the AI model may also include performing an action set to initiate resumption of the update process of the AI model. The action set may include identifying a period of time for the provisioning process to complete. The period of time may be identified by performing a statistical analysis of historical process activity information of the downstream consumer. For example, the statistical analysis may include obtaining mean and/or median periods of time for historical processes initiated by the downstream consumer. The period of time may also be identified using an AI model trained to estimate the period of time for a provisioning process initiated by the downstream consumer (e.g., similar to or same as the AI model discussed in operation 302, the AI model being trained using the historical process activity information).

The action set for initiating resumption of the update process may be performed by, for example, providing instructions to the update process. For example, the instructions may include modifying a wait time parameter in code used by the update process to include a wait time that is at least the period of time. The instructions may also include suspending the update process until further instructions are received (e.g., via a second notification that may be transmitted to the update process after at least the period of time has passed) that may instruct the update process to resume its updates (e.g., after the provisioning process initiated in operation 302 has completed).

In a second example, the update process for the instance of the (identified) AI model may not be suspended during the provisioning process, allowing for updates to the AI model used to provide the set of consistent inferences to the downstream consumer. Thus, identifying the instance of the AI model may include identifying, during the provisioning process, a first instance of the AI model used to service a first inference request for inferences used in the provisioning process.

The first instance of the AI model may be identified by querying the database that manages a repository (e.g., trained AI model repository 206) that may store the different instances of the AI model. The database query may include identifying information for an instance of the AI model that is associated with an identifier the first inference request of the provisioning process. Based on the database query result, the repository may provide trained AI model data for the first instance of the AI model for use in an inferencing process (see the description of FIG. 2B for more information regarding inferencing processes). The first instance of the AI model may be used as the instance of the AI model (e.g., for obtaining inferences during the provisioning process).

After identifying the first instance of the AI model, a second instance of the AI model generated by the update process (e.g., running concurrently to the provisioning process of operation 302) may be identified. At its time of identification, the second instance of the AI model may be an updated version of the first instance of the AI model (e.g., the second instance of the AI model may be a more up to date instance than the first instance of the AI model). The second instance of the AI model may be identified by receiving a notification (e.g., from the update process (e.g., training process 204), from another entity responsible for updating the AI model, etc.). The notification may, for example, indicate an updated instance of the AI model associated with the downstream consumer is available. The second instance of the AI model may also be identified by performing a monitoring process (e.g., that may check for updated instances of the AI model at regular intervals) to identify updated instances of the AI model.

After identifying that the second instance of the AI model is available, during the provisioning process (e.g., where subsequent requests for inferences may be received), all subsequent requests for inferences used in the provisioning process may be serviced using the first instance of the AI model (rather than newer instances of the AI model generated by the update process). The subsequent requests for inferences used in the provisioning process may be serviced by obtaining inferences associated with the subsequent requests and/or making the inferences available for consumption by the downstream consumer.

For example, the subsequent requests for inferences used in the provisioning process may be serviced by (i) obtaining a copy of the first instance of the AI model, (ii) making the copy available for use in an inferencing process (e.g., inferencing process 222 or an inferencing process performed by a third party), (iii) notifying an entity responsible for inference generation to use the first instance of the AI model exclusively during the provisioning process, (iv) storing the second instance of the AI model and/or any subsequently updated instances of the AI model in a repository (e.g., trained AI model repository 206), (v) labeling the second instance of the AI model and/or the any subsequently updated instances of the AI model as candidates for inference generation for future provisioning processes (e.g., future provisioning processes occurring after the provisioning process has completed), and/or (vi) updating a historical process activity repository (e.g., historical process repository 218) to reflect that the first instance of the AI model repository may be used during the provisioning process initiated by the downstream consumer.

At operation 324, the set of consistent inferences may be obtained using the instance of the AI model (e.g., the instance of the AI model identified in operation 322). The set of consistent inferences may be obtained by obtaining inferences for all requests used during the provisioning process. For example, the inferences may be obtained by (i) reading the inferences from storage, (ii) receiving the inferences from another device, and/or (iii) performing a process to generate the inferences (e.g., an inferencing process).

For example, the set of consistent inferences may be generated by feeding ingest data (e.g., associated with the requests for inferences, the ingest data being obtained from the downstream consumer and/or other data sources) to the instance of the AI model during an inferencing process. During the provisioning process, the instance of the AI model may produce inferences or all requests (e.g., of the set of consistent inferences) as output in response to the ingest data.

The method may end following operation 324.

Thus, as illustrated above, embodiments disclosed herein may provide systems and methods usable to manage instances of AI models that may be updated over time (e.g., evolving AI models). By identifying an instance of an AI model to be used during an inference consumption process for a downstream consumer, the likelihood of providing consistent inferences to the downstream consumer may be increased. Additionally, the likelihood of obtaining poisoned AI models and/or poisoned inferences (e.g., via poisoned training data introduced during the inference consumption process) may be reduced.

Thus, embodiments disclosed herein may provide an improved computing device that is able to increase the likelihood of providing desired computer-implemented services that rely on the provision of consistent inferences. Accordingly, the disclosed process provides for both an embodiment in computing technology and an improved method for managing secure data access.

Any of the components illustrated in FIGS. 1-3B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as Vx Works.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing evolving artificial intelligence (AI) models, comprising:
making an identification that a downstream consumer will perform a process, the process comprising consuming inferences from an AI model of the evolving AI models, the AI model being subject to an update process, and the update process being used to generate different instances of the AI model; and
while the process is being performed, providing a set of consistent inferences to the downstream consumer using an instance of the different instances of the AI model to facilitate completion of the process.

2. The method of claim 1, wherein providing the set of consistent inferences comprises:
identifying the instance of the AI model usable to generate the set of consistent inferences for the downstream consumer; and
obtaining the set of consistent inferences using the instance of the AI model.

3. The method of claim 2, wherein identifying the instance of the AI model comprises:
suspending the update process for the instance of the AI model; and
using a most up to date instance of the AI model as the instance of the AI model.

4. The method of claim 3, wherein identifying the instance of the AI model further comprises:
performing an action set to initiate resumption of the update process for the instance of the AI model to obtain an updated instance of the AI model.

5. The method of claim 4, wherein the action set comprises:
identifying a period of time for the process to complete; and
waiting at least the period of time before performing an action of the action set to resume performance of the update process.

6. The method of claim 2, wherein identifying the instance of the AI model comprises:
during the process:
identifying a first instance of the AI model used to service a first inference request for inferences used in the process; and
using the first instance of the AI model as the instance of the AI model.

7. The method of claim 6, wherein using the first instance of the AI model as the instance of the AI model comprises:
during the process:
after identifying the first instance of the AI model, identifying that a second instance of the AI model has been generated by the update process, the second instance of the AI model being an updated version of the first instance of the AI model; and
after identifying that the second instance of the AI model has been generated, servicing all subsequent requests for inferences used in the process with the first instance of the AI model rather than the second instance of the AI model and any subsequent instance of the AI model generated by the update process to provide the set of consistent inferences.

8. The method of claim 6, wherein at a time of identification of the first instance of the AI model, the first instance of the AI model is a most up to date version of the AI model.

9. The method of claim 1, wherein facilitating completion of the process comprises providing a computer-implemented service using the set of consistent inferences.

10. A non-transitory machine-readable medium having instructions stored therein, which when executed by a processor, cause the processor to perform operations for managing evolving artificial intelligence (AI) models, the operations comprising:
making an identification that a downstream consumer will perform a process, the process comprising consuming inferences from an AI model of the evolving AI models, the AI model being subject to an update process, and the update process being used to generate different instances of the AI model; and
while the process is being performed, providing a set of consistent inferences to the downstream consumer using an instance of the different instances of the AI model to facilitate completion of the process.

11. The non-transitory machine-readable medium of claim 10, wherein providing the set of consistent inferences comprises:
identifying the instance of the AI model usable to generate the set of consistent inferences for the downstream consumer; and
obtaining the set of consistent inferences using the instance of the AI model.

12. The non-transitory machine-readable medium of claim 11, wherein identifying the instance of the AI model comprises:
suspending the update process for the instance of the AI model; and
using a most up to date instance of the AI model as the instance of the AI model.

13. The non-transitory machine-readable medium of claim 12, wherein identifying the instance of the AI model further comprises:
performing an action set to initiate resumption of the update process for the instance of the AI model to obtain an updated instance of the AI model.

14. The non-transitory machine-readable medium of claim 13, wherein the action set comprises:
identifying a period of time for the process to complete; and
waiting at least the period of time before performing an action of the action set to resume performance of the update process.

15. The non-transitory machine-readable medium of claim 11, wherein identifying the instance of the AI model comprises:
during the process:
identifying a first instance of the AI model used to service a first inference request for inferences used in the process.

16. A data processing system, comprising:
a processor; and
a memory coupled to the processor to store instructions, which when executed by the processor, cause the processor to perform operations for managing evolving artificial intelligence (AI) models, the operations comprising:
making an identification that a downstream consumer will perform a process, the process comprising consuming inferences from an AI model of the evolving AI models, the AI model being subject to an update process, and the update process being used to generate different instances of the AI model, and
while the process is being performed, providing a set of consistent inferences to the downstream consumer using an instance of the different instances of the AI model to facilitate completion of the process.

17. The data processing system of claim 16, wherein providing the set of consistent inferences comprises:
identifying the instance of the AI model usable to generate the set of consistent inferences for the downstream consumer; and
obtaining the set of consistent inferences using the instance of the AI model.

18. The data processing system of claim 17, wherein identifying the instance of the AI model comprises:
suspending the update process for the instance of the AI model; and
using a most up to date instance of the AI model as the instance of the AI model.

19. The data processing system of claim 18, wherein identifying the instance of the AI model further comprises:
performing an action set to initiate resumption of the update process for the instance of the AI model to obtain an updated instance of the AI model.

20. The data processing system of claim 19, wherein the action set comprises:
identifying a period of time for the process to complete; and
waiting at least the period of time before performing an action of the action set to resume performance of the update process.
